(19) United States
(12) Patent Application Publication
(10) Pub. No.: US 2012/0095941 A1
(43) Pub. Date: Apr. 19, 2012

(54) Method and Apparatus For Welding Cost Calculator

(75) Inventors: Grant A. Dolson, Dundas (CA); Anthony J. Kowaleski, Manawa, WI (US); Robert R. Davidson, New London, WI (US); Bruce Alan Casner, Neenah, WI (US); Knut Norman Froland, Green Bay, WI (US); L. Thomas Hayes, Appleton, WI (US); Richard John Schuh, Kaukauna, WI (US)

(73) Assignee: Illinois Tool Works Inc., Glenview, IL (US)

(21) Appl. No.: 13/204,410

(22) Filed: Aug. 5, 2011

Related U.S. Application Data
(63) Continuation-in-part of application No. 12/983,049, filed on Dec. 31, 2010.
(60) Provisional application No. 61/303,378, filed on Feb. 11, 2010.

(51) Int. Cl. G06F 17/00; B23K 9/095; B23K 9/10; B23K 9/00

(52) U.S. Cl. 705/400; 219/136; 219/130.21

(57) ABSTRACT

A method and apparatus for providing welding-type power is disclosed and includes a cost calculator.

### RELATED APPLICATIONS

This is a continuation-in-part of, and claims the benefit of the filing date of U.S. patent application Ser. No. 12/983,049, filed Dec. 31, 2010, entitled Welding-Type System With Cost Calculator, which claimed the benefit of U.S. 61/303,378, filed Feb. 11, 2010, entitled was a continuation-in-part of application Ser. No. 11/331,466, filed Jan. 13, 2006, entitled Welding-Type System With Cost Calculator.

### FIELD OF THE INVENTION

The present invention relates generally to the art of welding-type power supplies and welding operations. More specifically, it relates to a welding-type power supply with a cost calculator built, or to a method of calculating costs of welding.

### BACKGROUND OF THE INVENTION

There are many known welding-type systems used to provide a welding-type output or welding-type power for many known applications. Welding-type system, as used herein, includes any device capable of supplying welding, plasma cutting, and/or induction heating power including invertors, convertors, choppers, resonant power supplies, quasi-resonant power supplies, etc., as well as control circuitry and other ancillary circuitry associated therewith. Welding-type output, as used herein, includes outputs suitable for welding, plasma or heating. Welding type power, as used herein, refers to welding, plasma or heating power.

Examples of prior art welding-type systems include those described in Method of Designing and Manufacturing Welding-Type Power Supplies. Albrecht, filed Sep. 19, 2001, application Ser. No. 09/956,401, which issued on Mar. 30, 2004 as U.S. Pat. No. 6,713,721; Pendant Control for a Welding-Type System, L. Thomas Hayes, filed Sep. 19, 2001, application Ser. No. 09/956,502, which issued on Oct. 28, 2003 as U.S. Pat. No. 6,639,182; Welding-Type Power Supply With A State-Based Controller. Holverson et al. filed Sep. 19, 2001, application Ser. No. 09/956,548, which issued on Jun. 8, 2004 as U.S. Pat. No. 6,747,247; Welding-Type System With Network And Multiple Level Messaging Between Components. Davidson et al. filed Sep. 19, 2001, application Ser. No. 09/957,707, which issued on Dec. 30, 2003 as U.S. Pat. No. 6,670,579; Welding-Type Power Supply With Boot Loader. L. Thomas Hayes, filed Sep. 19, 2001, application Ser. No. 09/956,405, which issued on Jan. 7, 2003 as U.S. Pat. No. 6,504,131; and Welding-Type System With Robot Calihration, Rappl et al., filed Sep. 19, 2001, application Ser. No. 09/956,501, which issued on Nov. 4, 2003 as U.S. Pat. No. 6,642,482. Each of these patents is hereby incorporated by reference.

It is often desirable to know the cost to weld a component (or a number of different components). Determining the cost to weld a component requires the end user to do a time study, and/or gathering data such as parts per hour, parts per spool of wire, time the operator spends welding, time loading parts, amount of wire and shielding gas consumed, and electricity used. Gathering such data can be time consuming, costly, and inaccurate. One prior art system that performs such data gathering is described in U.S. Pat. No. 6,583,386, which is hereby incorporated by reference.

Moreover, this might need to be done for each welding cell for each shift and operator. This may also need to be repeated often, as production variables may change over time. For example, an operator may weld a first part fast, but not as efficient at welding a second part, and thus so operator efficiency, weld parameters and spatter generation will not be the same. Changes in manufacturing procedures may also affect the studies. Efficiencies improve as operators and weld engineers have more experience welding the part. New parts and fixtures are rarely optimized for production needs. Over the course of a product life improvements are made to fixtures, operators get more comfortable welding, weld engineers improve weld parameters, parts are made more accurately, etc.

Some systems include sophisticated programming and/or data monitoring. However, that data has generally been used to control the welding process. There remains a need for a welding-type system that includes an effective way to calculate the cost of a welding operation and efficiencies of welding-type systems, preferably using data from the welding-type system. Accordingly, a welding-type system that includes a cost calculator, or a cost calculator for welding is desired.

### SUMMARY OF THE PRESENT INVENTION

According to one aspect of the invention a welding-type system includes a cost calculator that uses data from the welding-type system controller, including data from the weld, to determine the cost of a weld. Other information, such as permit labor costs, energy costs, material costs, etc., may be used as well.

According to a second aspect a welding cost calculator uses data from a welding-type system controller, including data from the weld, to determine the cost of a weld. The cost calculator may reside in software that is not part of the welding-type system, but preferably works with the welding-type system. Other information, such as per unit labor costs, energy costs, material costs, etc., may be used as well.

Other principal features and advantages of the invention will become apparent to those skilled in the art upon review of the following drawings, the detailed description and the appended claims.

### BRIEF DESCRIPTION OF THE DRAWINGS

FIG. 1 is a welding-type system in accordance with the preferred embodiment of the present invention;

FIG. 2 is block diagram in accordance with the preferred embodiment of the present invention; and

FIG. 3 is a block diagram of a welding cost calculator in accordance with the preferred embodiment of the present invention.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to a particular welding-type system it should be understood at the outset that the cost calculator can be implemented with other welding-type systems, or as a stand-alone unit, preferably connected to a welding-type system. Cost calculator, as used herein, includes software and/or hardware, found in one or more locations, used to calculate the cost of one or more welding processes, or aspects of one or more a welding processes. The cost calculator may be part of a system controller, a separate module of a system, or a stand-alone unit that is preferably connected to (physically and/or a data connection such as over a network) a welding-type system. The cost calculator may use otherwise available data, or receive data specifically obtained or intended for the cost calculator. Data can be sensed, measured, or obtained from a user input. Module, as used herein, includes software and/or hardware that cooperates to perform one or more tasks, and can include digital commands, control circuitry, power circuitry, networking hardware, etc.

The preferred embodiment provides for implementing the invention with the Miller Axcess® or Miller AxcessE® welding power supply. The Axcess® or AxcessE® can include weld data logging and/or monitoring and/or a real time clock and a cost calculator in the preferred embodiment.

The preferred embodiment provides that the cost calculation be performed using one or more of cost data and data related to sensed data, program parameters, quantity of materials used and type of materials used (some data will full in more than one category).

Sensed parameters include time based data and welding output data. Time based data includes part cycle time, arc on time, weld time, idle time, time spent welding, time spent loading parts and off time (when the welding-type system is not powered up). Welding output data includes wire usage, gas usage, power, current, voltage, spatter, etc. The power, current and voltage can be input, output, or intermediary values. In the preferred embodiment the sensed data is data sensed by the system controller and provided to the cost calculator, to reduce the need for redundant sensing. The wire used and utilization can be determined from wire feed speed, current, time, etc. Spatter can be estimated or calculated (as described below), and correlates to grinding time. Consumable usage (tips, liner, torch life) can be estimated from welding current.

Program parameters include data used by the system controller to control the power output, and can be user-input, derived from charts, tables, programs, etc. Program parameters include ramp time, ramp slope, peak current, background current, wire type (including size and composition), gas type, gas flow rate, gas usage, amount of materials used. In the preferred embodiment the program parameter data is data provided by the system controller to the cost calculator, to reduce the need for the user to enter the data a second time. Users can also input number of scrap parts, hours worked amount of material used.

Cost data can be input by the user to the system controller, or to the cost calculator, or can be derived from other sources (power cost, for example could be obtained via a network form the power company, wire costs from a supplies or a purchasing department). Costs data includes costs of power, power factor costs, costs of wire, costs of gas, operators hourly pay rate, etc.

The preferred embodiment provides for the cost calculator to be a function embedded into an external weld-cell PC, such as the Insight Centerpoint™ PC application. The cost calculator allow users to determine the cost of welding a component, and to track any change or trending in those costs over time. The cost of fabricating a component is preferably calculated using the welding information used by the PC, and pro'vided at least in part by the welding system controller, for a particular part and multiplying that times cost data provided by the user. The user can provide the cost data to the PC or to the system controller. A history (or log) of this fabrication cost will be captured by the system and stored for comparative purposes.

Preferably, a master cost table includes all needed cost elements of the welding inputs used in the fabrication of various parts. This table can be populated with costs by the user of the system, or can obtain the data from elsewhere, such as over a network, wirelessly, etc. These elements preferably include the cost of labor, the cost of filler metal, the cost of shielding gas, and the cost of electricity. The gas blend type and wire types are preferably selected using pre-defined pull-down lists, that are preferably derived from the welding system controller. An example of the table is pictured below.

| Cost Element | Cost | Cost Element | Cost |
|---|---|---|---|
| Labor | $ dollars per hour | Wire #1 | $/lb |
| Electricity | $ per kwh | Wire #2 | $/lb |
| Gas blend #1 | $ per CFH | Wire #3 | $/lb |
| Gas blend #2 | $ per CFH | Wire #4 | $/lb |
| Gas blend #3 | $ per CFH | Wire #5 | $/lb |

The exemplary table above takes into account the likelihood that a user will have more than one type of shielding gas as well as multiple types and sizes of wire. The cost used in the calculation of the total gas and wire costs will be provided by the welding system controller based on the gas and wire information that is selected by the operator of the welding system. In other words, if the welding machine is set to 0.045″ solid steel wire and 90/10 gas (i.e., running a program for those materials), the costs for those elements will be used in the calculation of the overall cost to fabricate the component.

Calculating cost is preferably fairly straightforward—multiplication and addition. The cost of labor preferably includes any intra-cycle downtime that might occur. The preferred labor cost calculation is labor cost/hr multiplied by the total cycle time (time between cycle start, and cycle end). If downtime occurs during a fabrication cycle, the amount of time should be noted, as should the downtime type. Wire cost is cost of wire/lb multiplied by lbs used between cycle start and cycle end. Cost of gas is cost of shielding gas/CFH multiplied by the number of CFHs used between the cycle start and the cycle end. Tracking gas flow will require the use or a gas flow sensor, or other input. The cost of electricity is the cost per kwh multiplied by the electricity used (which can be measured at the input, or derived from the output). The total cost is the sum of the costs above. These costs are tied to a specific part type.

The PC/application preferably includes a button/link/menu choice on the HMI (human machine interface). Preferably, there is also a “Live Part View” that is labeled “Cost.” Like many buttons on the HMI, there is preferably an option to either show or hide the button based on the sign-in privilege of the person logged into the system. This button should bring up a window that summarizes the cost for the completed part, broken down by the various elements (labor, wire, etc.). This information should be stored in the system just like the Link to Weld Signature and Link to Report View, and should pop up on the menu that same sub-menu. The total cost of the part and a history view for a specific part type should be created to allow the user to see cost trends of a particular part over time. A similar report should be made available in the program running on the PC, such as Insight Reporter™.

The preferred embodiment provides that the cost calculator automatically tracks the time required to make a part, the idle time, wire used, gas used and power usage. It also includes an algorithm to determine spatter production to generate a percent wire utilization (how much wire is actually on the weld, and how much ended up as spatter on the part or fixture). One such algorithm uses the relationship between the current when the short clears, and spatter. Generally speaking, spatter is responsive to the square of the current when the short clears. For some processes and materials it is proportional, and the constants (K1 and K2 in spatter=K1+K2*I*1, where * is multiplied) can be determined empirically. Alternatives provide for using other functions of current, such as spatter=K1+K2*1, or K3+K2*1+K1+I*1, or other functions of I, or a function of the time in the short relative to the time in the arc, etc.

Alternatives include having user input such as using a PC application, a web page, or a USB key that allows the user to enter and adjust their costs for labor, wire, gas, power, etc, or obtain costs data automatically via a network, such as from a server. The system uses this information to calculate the costs of welding. This allows the user to focus on parts/welds that increase or maximize productivity and profits. The calculated cost information may also be used as a measurable number to justify and/or analyze improvements implemented in a weld cell.

Various alternatives include providing web screen plots showing the output of the cost calculator (i.e., cost for various factors for a welding operation). The cost calculator preferably tracks one or more of: time between parts, part production cycle time, time spent welding, gas usage, wire usage, spatter (estimated), and power usage.

The cost calculator then uses the tracked information to determine time spent welding, time spent loading parts (system on but not welding), gas costs, wire costs (the spatter estimate will help with wire cost). Additional parameters, such as per unit wire cost, per unit energy cost, per unit material cost, etc., can be provided by the user, obtained over a network such as from a server, or input at a later time. The parameters can be fixed or given ranges, so that as material costs or energy costs, for example, vary, the cost calculator can determine the relative costs of various parts, and production can be adjusted to maximize profit.

Alternatives include consumable usage (tips, liner, torch life—estimated from welding current), using a real time clock to account for breaks (when the user is idle for more than a given time). The number of scrap parts can be entered via web page, obtained from a server, or other data entry method.

The time tracking is preferably obtained through an operator interface. The operator indicates the start of new part in the weld cell and the part completion. The time could be measured as start of a part to start on next part, end of a part to end of next part or start of any specified weld till the start of the next parts specified weld. The operator could push a button indicating the start, or the time could be automated. For example, time could be started based on when a clamp is placed on a fixture, input from a PLC or robot, current output, etc.

The times that are acquired preferably include total part time (new part to next new part time or part production cycle time), weld time (first weld of part, till last weld of part), arc on time (total time spent with the welding arc on), load time (estimate of time spent loading parts which can be estimated by load time=total part time−weld time), off time (when the welding-type system is not powered up). The welding-type system preferably includes a real time clock with battery back-up so it can maintain time while off, or the welding-type system has access to an external source of time. Time off, such as breaks, shift changes, lunch, etc. can be determined by an unusually length time between the end of one part and the start of the next, by being tied to the facilities employee time clock, or by sensing an employee's ID card.

Consumable-related variables include one or more of: wire usage (based on motor feedback the wire used is measured, but there might be errors due to slippage of the drive rolls on the wire and an alternative provides for using an external wirefeed speed sensor), an algorithm estimates the amount of spatter produced while welding, which correlates to grinding time and wire utilization (how much wire ended up in the weld and how much ended up on the floor), gas usage (flow rate may be entered via a web page, from a server, or other data input source, and the system tracks the time the gas is on to estimate gas usage, an alternative includes a gas flow sensor which gives real time feedback and improved accuracy), and power (estimated by output power of the welder, times an efficiency factor, and feeder power used by the system while in standby can be included, as well as auxiliary output power (115 AC), and an alternative is to sense the primary voltage and current and calculate based on power factor).

User or system inputs may be obtained using a web interface, from a server or other network source, wirelessly, or in any other convenient manner. These inputs include one or more of costs of power, power factor costs, costs of wire, costs of gas, gas flow rate (if no sensor provided), operators hourly pay rate (burdened or not) which is preferably tied to an operator log-in screen, or USB key, employee ID card, biometrics (fingerprint scanner, e.g.) etc., so as an operator logs in the appropriate hourly rate is applied, and/or cost of the part to be welded.

The cost calculator uses log files to track cost by part, shift, day, week, month and/or operator. The cost calculator can determine up-to-date and accurate production costs, benchmark production improvements and accurately measure the resulting savings, focus on areas with significant opportunities for cost improvement, allow for flow analysis (determine where a part spends time as it travels along a production line), identify long fixture load times vs weld times, which indicate a fixture or cell layout issues, and allocate the hourly wage of an operator to the part being produced.

Alternatives provide that the cost calculator software that acquires and analyzes data reside in a computer or controller in the cell, in the feeder, in the power supply, in a PLC or in a robot. Acquisition of data may done in the weld cell and then sent to a remote location (networked computer, USB key . . . ) for analysis of cost. The analysis can be clone in real time, or after an operation has ended.

Various embodiments provide for using each of the above parameters, additional parameters, or less than all of the above parameters (with or without other parameters). For example, one embodiment provides that the cost calculator use part cycle time, arc on time, wire usage, power, costs of power, costs of wire, and operators hourly pay rate to determine the cost of the part. Another embodiment provides that the cost calculator use part cycle time, weld time, arc on time, wire usage, gas usage, power, costs of power, costs of wire, costs of gas, gas flow rate and operators hourly pay rate to determine the cost of the part.

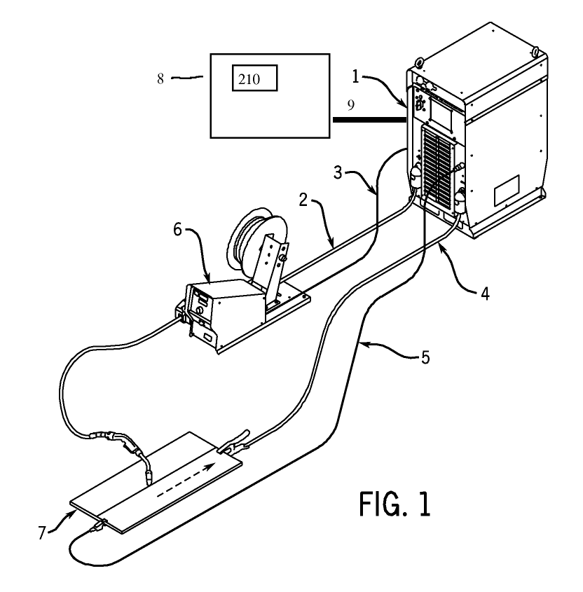

Referring to FIG. 1, a welding-type system 100 includes a power supply 1, and a wire feeder 6, which cooperate to provide power over a pair of weld cables 2 and 4 to a workpicce 7. Feeder cable 3 and a voltage sense cable 5 are used for control/feedback. The system shown is an Axcess® welding system, but the invention may readily be implemented with other welding-type systems. Welding system 100 performs generally as prior art welding systems, but includes a cost calculator as part of a controller in one embodiment, or as a personal computer 8, as part of the weld cell. In the preferred embodiment data is provided to PC 8 from the welding system controller.

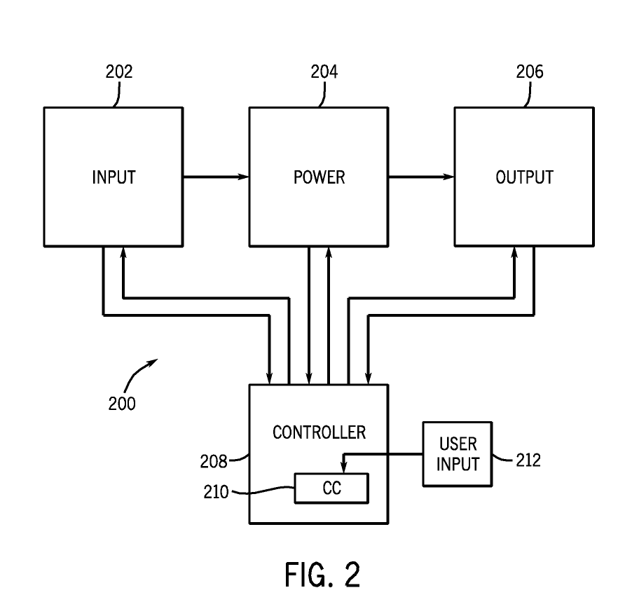

Referring now to FIG. 2, a diagram shows a welding-type system 200 includes an input circuit 202, a power circuit 204, and an output 206, as well as a controller 208 and a user cost input module 212. Circuits 202, 204 and 206, and controller 208, are part of welding power supply 1 (FIG. 1) in the preferred embodiment. They are distributed over several locations (such as wire feeder 6, an external control circuit, etc.) in other embodiments. Circuits 202, 204 and 206, and controller 208 are functional blocks and need not be physically distinct circuits.

Circuits 202, 204 and 206, are, in one embodiment, consistent with those shown in U.S. Pat. No. 6,329,636, entitled Method And Apparatus For Receiving A Universal Input Voltage In A Welding, Plasma Or Heating Power Source, issued Dec. 11, 2001, which is hereby incorporated by reference. Accordingly, circuits 202, 204 and 206 may include circuitry to rectify, boost, power factor correct, invert and transform different input powers into welding-type power.

Controller 208 includes much of the control circuitry of the prior art, including that used to turn switches on and off circuits 202, 204 and 206. This switch control circuitry can be implemented with other control circuitry, including digital, analog, and include microprocessors, DSPs, analog circuitry, etc. Also, controller 208 includes cost calculator 210, or it resides in PC 8, as shown in FIG. 1. Cost calculator 210 resides primarily in data acquisition hardware that is part of the welding system, and software implemented on a microprocessor in the preferred embodiment. Alternatives provide for cost calculator 210 to not be part of controller 208, such as external device, such as a pc or pda, located in the weld cell or remotely (and communicates with welding-type system 100 over a network or dedicated connection).

User cost input module 212 allows for the user to input cost data, such as material cost, labor cost, and can include quantitative information such as the hours worked, amount of material used, amount of welding performed, etc., if such information is not obtained via sensing or measurement. User input module 212 includes a data entry device, such as a keyboard in one embodiment, and is a pc or other computing device in another embodiment. It is linked to cost calculator module 210 via a network. (wired or wireless) or via a dedicated connection in various embodiments.

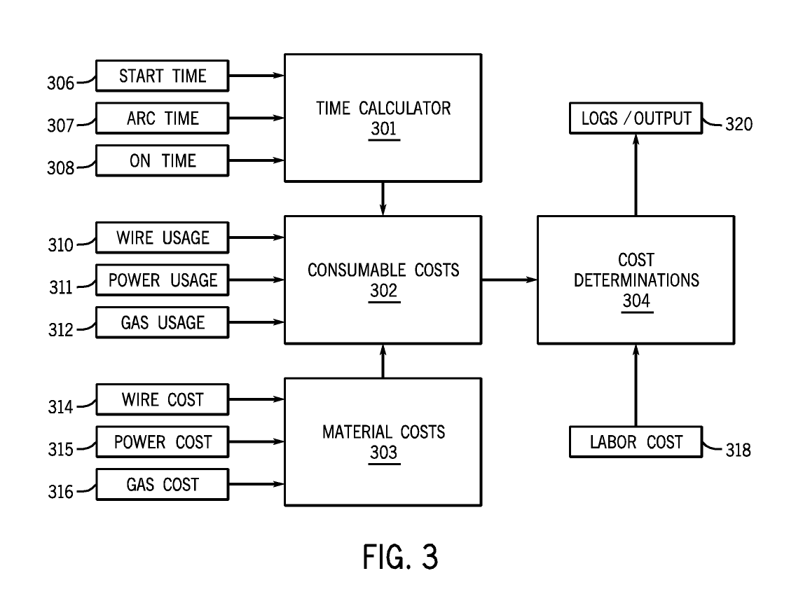

Referring now to FIG. 3, a diagram of one embodiment of cost calculator 210 includes a time calculator 301, a consumable cost module 302, a material cost module 303, and a cost determination module 304. The various blocks represent functional modules_that are implemented using software. One skilled in the art could readily have other functional blocks, or combine functions in other ways.

Time calculator 301 receives signals indicative of a welding of a part being started 306, the arc being on 307, and the power supply being on 308. As described above, these times may be derived from the clamp being placed on the part, and from power supply 204 and/or controller 208. Time calculator 301 preferably includes a real time clock. From the various signals 306-308 and the RTC signal time calculator 301 can determine the total part time, arc (weld) time, load time, and off time of welding-type system 100, by noting the RTC time when the various signals are received. Alternatives provide for the time to be provided to time calculator 301.

Consumable cost module 302 receives as inputs signals indicative of wire usage 310, power usage 311, and gas usage 312. As described above, wire usage 310 is determined from wire motor feedback or from an external sensor. Power usage 311 is determined from power output of the welder, times an efficiency factor, feeder power and auxiliary output power (115 AC), or by sensing the primary voltage and current and calculate based on power factor. Gas usage 312 is determined from a user input of flow rate and the time the gas is on, or using a gas flow sensor.

Material cost module 303 receives as inputs the per unit wire cost 314, power cost 315, and gas cost 316. It provides this information to consumable cost module 302, which uses that and the information indicative of the quantity of consumables used to calculate consumable costs. The inputs are preferably from a web page, but could be input over a network, on a pendant, on a portable storage device such as a USB drive, or obtained manually or automatically from a server or other network location.

Cost determination module 304 receives data from consumable cost module 302, and receives labor cost input 318. The labor cost input is preferably obtained using the employee ID and a data base, but could be from web page, over a network, from an employee ID card, on a pendant, USB drive etc., from a server, or other network locations.

Cost determination module 304 outputs that cost to a log or output 320. Output 320 is preferably a web page that is accessible over a network, emailed to a recipient, or displayed in the weld cell. It may also be stored locally, on a hard drive, external drive, USB drive, etc.) for later retrieval.

Alternatives include cost calculator 210 being implemented with other functional blocks, with other parameters, and located other than in controller 208.

Various alternatives provide that welding-type system 100 includes network communication, such as WAN, LAN, over power lines, over a smart grid, and that the data transmitted and/or stored, such as on a usb drive, include arc parameters and primary information, such as harmonics data, utilization data, etc. The information can be shared over the network or using a drive with end users, power companies, manufacturers that use welders, manufactures that supply welders, etc. Additionally, various alternatives and arrangements are shown in the attached appendix.

Numerous modifications may be made to the present invention which still fall within the intended scope hereof. Thus, it should be apparent that there has been provided in accordance with the present invention a method and apparatus for a welding-type system with a cost calculator that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

The embodiments of the invention in which an exclusive property or privilege is claimed are defined as follows:

1. A welding-type system, comprising:
a source of welding-type power;
a controller, including a control output connected to the source of welding-type power; and
a cost calculator, having a data input connected to a data output on the controller, wherein the cost calculator receives data from the controller on the data input, wherein the data is used in a cost calculation performed by the cost calculator.

2. The welding-type system of claim 1, further comprising a sensed data input module, connected to provide sensed data on the data output to the data input, wherein the data includes sensed data.

3. The welding-type system of claim 2, wherein the sensed data input module is disposed to receive at least one of time-based data, welding output data, and gas related data, wherein the sensed data includes the at least one of time-based data, welding output data and gas related data.

4. The welding-type system of claim 1, further comprising a welding program data input module, connected to provide welding program data on the data output to the data input, wherein the data includes welding program data.

5. The welding-type system of claim 4, wherein the welding program data input module is disposed to receive at least one of gas usage data, gas type data, wire type data, and wire diameter data, wherein the welding program data includes the at least one of gas usage, gas type, wire type, and wire diameter.

6. The welding-type system of claim 1, further comprising a user-input data module, connected to provide user-input data on the data output to the data input, wherein the data includes user-provided data.

7. The welding-type system of claim 6, wherein the user-input data module is a user cost input module and wherein the user-provided data includes at least one of costs of power, power factor costs, costs of wire, costs of gas, and operator pay.

8. The welding-type system of claim 3, wherein the cost calculator further includes a time calculator connected to a cost determination module.

9. The welding-type system of claim 7, wherein the cost calculator includes a consumable cost module connected to receive data from the user cost module, and a cost determination module connected to consumable cost module.

10. The welding-type system of claim 9, wherein the user cost module includes software residing on a personal computer.

11. A method of providing welding-type power, comprising:
receiving input power and converting it to welding-type power:
controlling the converting using a controller; and
calculating at least one aspect of the cost of performing a weld in response to data received from the controller.

12. The method of claim 11, further comprising sensing data and providing the sensed data to the controller, wherein the data received from the controller includes the sensed data.

13. The method of claim 12, wherein sensing data includes sensing at least one of time-based data, welding output data, and gas related data, wherein the data received from the controller includes the at least one of time-based data, welding output data and gas related data.

14. The method of claim 11, further comprising receiving welding program data, wherein the data received from the controller includes at least a portion of the welding program data.

15. The method of claim 14, wherein the data received from the controller includes at least one of gas usage data, gas type data, wire type data, and wire diameter data.

16. The method of claim 11, further comprising receiving user-input data, wherein the data received from the controller includes at least a portion of the user-input data.

17. The method of claim 16, wherein the user-input data includes at least one of costs of power, power factor costs, costs of wire, costs of gas, and operator pay.

18. A system for providing welding-type power, comprising:
means for receiving input power and converting it to welding-type power;
means for controlling the converting, connected to the means for receiving input power and converting it; and
means for calculating at least one aspect of the cost of performing a weld in response to data received from the means for controlling.

19. The system of claim 18, further comprising means for sensing data and providing the sensed data to the means for controlling, wherein the data received from the means for controlling includes sensed data.

20. The system of claim 19, further comprising means for receiving welding program data, wherein the data received from the means for controlling includes at least a portion of the welding program data.

21. The system of claim 20, further comprising means for receiving user-input data, wherein the data received from the means for controlling includes at least a portion of the user-input data.

22. A cost calculator for determining the cost of a weld made with a welding-type system comprising a microprocessor based calculator having a data input disposed to receive data from a welding-type system controller, wherein the data is used in a cost calculation performed by the calculator.

23. The cost calculator of claim 22, further comprising a sensed data cost module, connected to receive data sensed by the welding-type system.

24. The cost calculator of claim 23, wherein the sensed data cost module is disposed to receive at least one of time-based data, welding output data, and gas related data.

25. The cost calculator of claim 22, further comprising a welding program data cost module, connected to receive welding program data from the welding-type system.

26. The cost calculator of claim 25, wherein the welding program data cost module is disposed to receive at least one of gas usage data, gas type data, wire type data, and wire diameter data.

27. The cost calculator of claim 22, further comprising a user-input cost module, connected to receive user-input data from the welding-type system.

28. The cost calculator of claim 27, wherein the user-input cost module is disposed to receive at least one of costs of power, power factor costs, costs of wire, costs of gas, and operator pay.

29. The cost calculator of claim 24, further comprising a time calculator connected to a cost determination module, and disposed to receive time-related data from the welding-type system.

30. The cost calculator of claim 28, further comprising a consumable cost module connected to receive data from the user cost module, and a cost determination module connected to consumable cost module.

31. The cost calculator of claim 30, wherein the microprocessor based calculator includes software residing on a personal computer.

32. A method of calculating the cost or performing a weld, comprising calculating at least one aspect of the cost of performing a weld in response to data received from a welding-type system controller.

33. The method of claim 32, further comprising receiving data sensed by the welding-type system controller, and using the sensed data as part of the calculation.

34. The method of claim 33, wherein receiving includes receiving at least one of time-based data, welding output data, and gas related data.

35. The method of claim 32, further comprising receiving welding program data from the welding-type system controller.

36. The method of claim 35, wherein receiving includes receiving at least one of gas usage data, gas type data, wire type data, and wire diameter data.

37. The method of claim 32, further comprising receiving user-input data from the welding-type system controller.

38. The method of claim 37, wherein receiving includes receiving at least one of costs of power, power factor costs, costs of wire, costs of gas, and operator pay.

39. A cost calculator for calculating the cost of a weld made with a welding-type system, comprising:
means for receiving data from the welding-type system controller: and
means for calculating at least one aspect of the cost of performing a weld in response to the data received, connected to the means for receiving.

40. The cost calculator of claim 39, wherein the means for receiving includes means for receiving data sensed by the welding-type system.

41. The cost calculator of claim 40, wherein the means for receiving includes means for receiving welding program data from the welding-type system.

42. The cost calculator of claim 42, wherein the means for receiving includes meaning for receiving user-input data from the welding-type system.
